(19) United States
(12) Patent Application Publication
(10) Pub. No.: US 2009/0220298 A1
(43) Pub. Date: Sep. 3, 2009

(54) Securing device for hooper portion of paint ball gun

(76) Inventor: Yao-Gwo Gun, Taichung (TW)

Correspondence Address: Gan, Yao-Gwo, P.O. Box 44-2049, Taipei, 10668, TW

(21) Appl. No.: 12/071,937

(22) Filed: Feb. 28, 2008

(51) Int. Cl. B23Q 3/00

(52) U.S. Cl. 403/369; 269/48.1

(57) ABSTRACT

A hopper securing device includes a tubular member having a first end connected to the dropping hole of the paint ball gun and a second end in which a tube of the hopper extends. A nut is threadedly mounted to the second end of the tubular member and a bushing is located in the nut. The nut includes a groove defined in an inner periphery thereof and the bushing includes an engaging flange extending radially outward from an end thereof. The engaging flange is rotatably engaged with the groove. The bushing includes an inclined opening and a tapered outer periphery, a lower end of the tube extends beyond the bushing. The second end of the tubular portion is inserted between the nut and the bushing.

### BACKGROUND OF THE INVENTION

(1) Field of the Invention

The present invention relates to a securing device for securely positioning the hopper portion to the paint ball gun.

(2) Description of the Prior Art

A conventional hopper portion for a paint ball gun includes a hopper and a tube which is connected to the dropping hole in the paint ball gun so as to provide paint balls into the paint ball gun. A securing device is used to secure the hopper portion to the paint ball gun. It is noted that the tube of the hopper portion may have different sizes and the dropping hole of the paint ball gun is fixed so that the users have to match the proper hopper portions and the guns.

The conventional securing device known to applicant is disclosed in U.S. Pat. No. 6,588,412. The bushing disclosed is located between the tube of the hopper and the nut, the lower end of the bushing is not inserted into the tubular portion so that the lower end of the tube of the hopper portion is only positioned by a part of the bushing. The limited restriction force cannot secure the hopper portion and might fall down from the tubular portion by impact. Besides, the bushing includes a single opening which is defined axially through the wall of the bushing, the axial opening is squeezed to hold the tube of the hopper portion. However, because the lower end of the bushing does not contact other part so that only the upper portion of the axial opening is squeezed, the lower portion of the axial opening is not squeezed so that the tube of the hopper portion is not well held. Another embodiment of the bushing includes alternative axial recesses, however, the multiple axial recesses cannot provide a complete and sufficient grasp area to the tube of the hopper portion.

The present invention intends to provide a securing device for a hopper portion of a paint ball gun, the bushing includes a tapered outer periphery so as to be firmly engaged with the tubular member, and the tube of the hopper portion extends through the bushing the tubular member so that the tube can be well positioned.

### SUMMARY OF THE INVENTION

The present invention relates to a hopper securing device which comprises a tubular member having a first end and a second end, wherein the first end of the tubular member is connected to a dropping hole in a paint ball gun and the second end of the tubular member receives a tube extending from a hopper. A nut is mounted to the second end of the tubular member and a bushing is located in the nut. The nut includes a groove defined in an inner periphery thereof and the bushing includes an engaging flange extending radially outward from an end thereof, the engaging flange is rotatably engaged with the groove. The bushing includes an opening and a tapered outer periphery. A lower end of the tube extends beyond the bushing. The second end of the tubular portion is inserted between the nut and the bushing.

The primary object of the present invention is to provide a securing device for hopper portion of a paint ball gun, wherein the device can secure the tubes of hopper portions of different sizes.

Another object of the present invention is to provide a securing device for hopper portion of a paint ball gun, wherein the tube of the hopper portion is firmly grasped so that the hopper does not fall during games.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show securing device of the present invention;

FIG. 2 is a perspective view to show that the hopper portion is secured by the securing device the of the present invention, and

FIG. 3 is a partial cross sectional view to show the securing device to position the hopper portion.

### DETAILED DESCRIPTION OF THE PREFERRED EMBODIMENTS

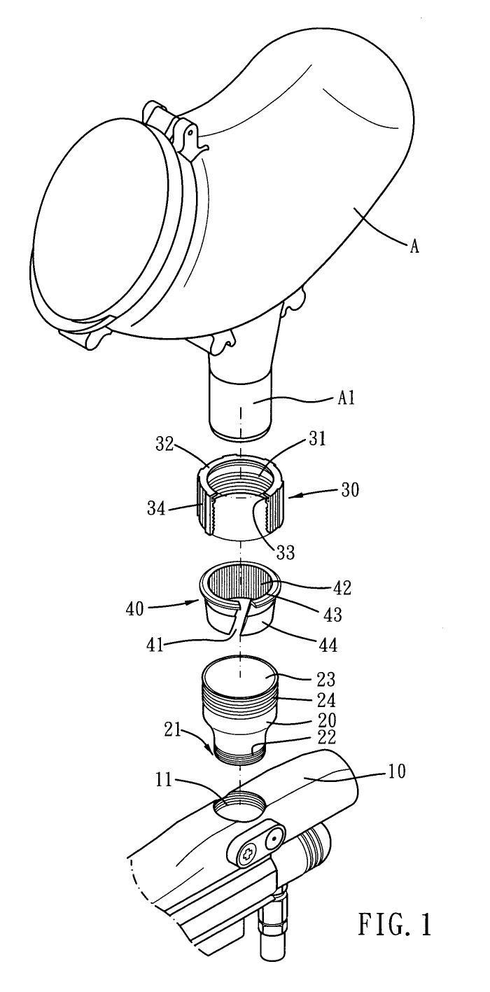

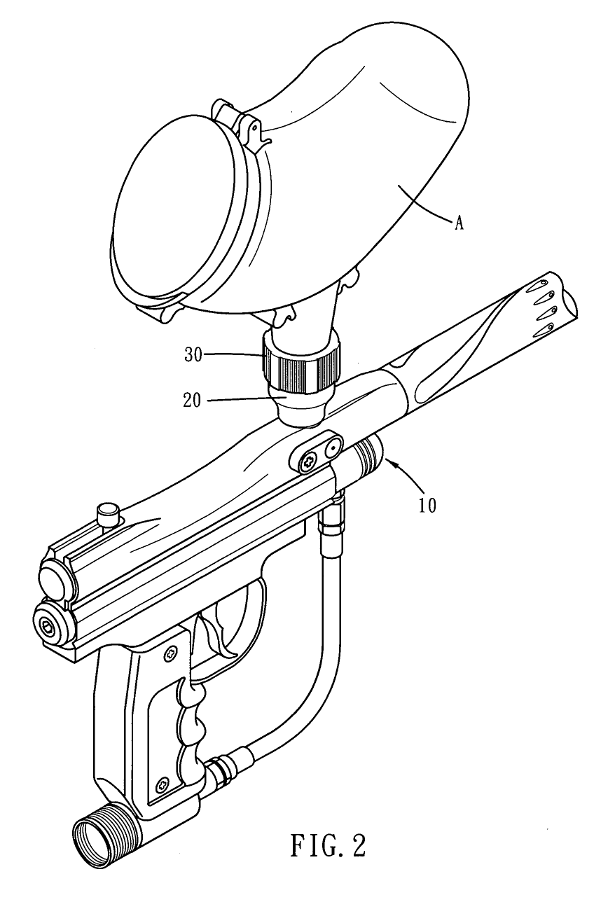

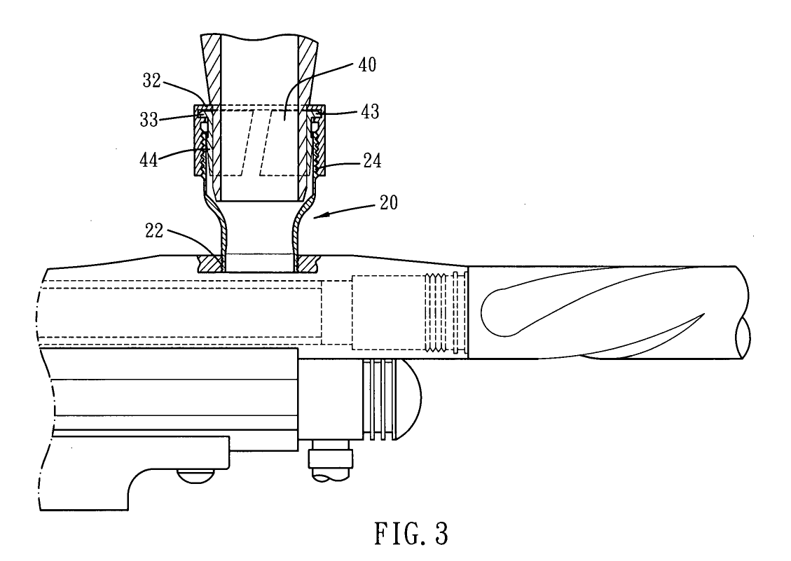

Referring to FIGS. 1 to 3, the securing device of the present invention comprises a tubular member 20 which includes a first end 21 and a second end 23, the first end 21 of the tubular member 20 includes outer threads 22 so as to be threadedly connected to a dropping hole 11 in a paint ball gun 10, and the second end 23 of the tubular member 20 includes outer threads 24. A tube “A1” extending from a hopper “A” is inserted into the second end 23 of the tubular member 20. The first end 21 of the tubular member 20 includes a narrowed inner periphery.

A nut 30 includes inner threads 31 which are threadedly connected with the threads 24 of the second end of the tubular member 20. The nut 30 including a groove 33 defined in an inner periphery thereof. A bushing 40 is located in the nut 30 and includes an engaging flange 43 extending radially outward from an end thereof. The engaging flange 43 is rotatably engaged with the groove 33. A top flange 32 extends inward from a top end of the nut 30 and is located above the groove 33. An inner diameter of a space enclosed by the top flange 32 is smaller than an outer diameter of the engaging flange 43, so that the bushing 40 is rotatably positioned in the nut 30. The bushing 40 includes an inclined opening 41 defined through a wall thereof and a tapered outer periphery 44. A lower end of the tube “A1” extends beyond the bushing 40. The second end 23 of the tubular portion 20 inserted between the nut 30 and the bushing 40. The bushing 40 includes a friction surface 42 defined in an inner periphery thereof and the friction surface 42 is in contact with the tube “A1” of the hopper “A”. When rotating the knurled portion 34 on the outside of the nut 30, the bushing 40 is squeezed to narrow the inclined opening 41 so as to firmly grasp the tube “A1” of the hopper “A”. Because the lower end of the tube “A1” extends beyond the lower end of the bushing 40, so that the tube “A1” is well positioned by the bushing 40 and this prevents the hopper “A” from falling from the paint ball gun 10 during games.

The engagement between the groove 33 of the nut 30 and the top engaging flange 43 of the bushing 40 position the bushing 40 in the nut 30 so that when the tube “A1” extends through the bushing 40, the bushing 40 does not offset from its central axis and this is convenient for the installation of the hopper “A”.

The bushing 40 can be replaced to be different size to secure the tubes “A” of the hoppers “A1” of different sizes. The friction surface 42 of the bushing 40 ensures that the tube “A1” of the hopper “A” does not shake during games.

While we have shown and described the embodiment in accordance with the present invention, it should be clear to those skilled in the art that further embodiments may be made without departing from the scope of the present invention.

What is claimed is:

1. A hopper securing device comprising:
a tubular member having a first end and a second end, the first end of the tubular member adapted to be connected to a dropping hole in a paint ball gun and the second end of the tubular member receiving a tube extending from a hopper, and
a nut mounted to the second end of the tubular member and a bushing located in the nut, the nut including a groove defined in an inner periphery thereof and the bushing including an engaging flange extending radially outward from an end thereof, the engaging flange rotatably engaged with the groove, the bushing including an opening and a tapered outer periphery, a lower end of the tube extending beyond the bushing, the second end of the tubular portion inserted between the nut and the bushing.

2. The device as claimed in claim 1, wherein the first end of the tubular member includes a narrowed inner periphery.

3. The device as claimed in claim 1, wherein a top flange extends inward from a top end of the nut and is located above the groove, an inner diameter of a space enclosed by the top flange is smaller than an outer diameter of the engaging flange.

4. The device as claimed in claim 1, wherein the bushing includes a friction surface defined in an inner periphery thereof and the friction surface is in contact with the tube of the hopper.

5. The device as claimed in claim 1, wherein the opening of the bushing is an inclined opening.

6. The device as claimed in claim 1, wherein the second end of the tubular member includes outer threads and the nut includes inner threads which are threadedly connected with the outer threads of the second end of the tubular member.
